(19) United States
(12) Patent Application Publication
(10) Pub. No.: US 2007/0244781 A1
(43) Pub. Date: Oct. 18, 2007

(54) System and method for organizing and evaluating regulation SHO threshold security listed stocks

(75) Inventor: Thomas Carter Ronk, Corona Del Mar, CA (US)

Correspondence Address: THOMAS C. RONK, 417 ORCHID AVE., CORONA DE MAR, CA, 92625, US

(73) Assignee: Thomas Carter Ronk, Corona Del Mar, CA (US)

(21) Appl. No.: 11/731,965

(22) Filed: Apr. 2, 2007

Related U.S. Application Data
(60) Provisional application No. 60/788,944, filed on Apr. 4, 2006.

(51) Int. Cl. G06Q 40/00

(52) U.S. Cl. 705/35

(57) ABSTRACT

A system and method for organizing and evaluating Regulation SHO Threshold Security Listed stocks is provided. The system provides for collection of data from multiple, dissimilar and disparate sources having various collection schedules by multiple data collectors. It further provides a central database for storage of the collected data with multiple mathematical and algorithmic calculations applied to the data. The central database has a central data store module for data storage and a central configuration module for configuring the data as well as the components of the system. The system includes a display module for generating and displaying on a website, general and user specific scheduled reports from the accessed data in the central database. The presentation of the data could be any time, anywhere and in any format required by the end user. The system also provides an administration module for collecting, monitoring and configuring the collected data, data collectors, central database and the reports for the end user(s).

### FIELD OF THE INVENTION

The present invention relates to a system for monitoring and analyzing an aggregate group of stocks in real time, more particularly it relates to a system for gathering, organizing in a relational, dynamic and analytical database stocks subject to Regulation SHO.

### BACKGROUND OF THE INVENTION

Naked short sales are sales of stock where the seller does not own the stock and has not borrowed the stock to cover the sale. The seller typically makes a naked short sale under the assumption that the stock will be go down below the naked short sale price in the future. Naked short sales have the potential for seriously disrupting orderly trading in stock markets since there is potentially no limit on how much of a particular stock can be sold in an aggregate number of contemporaneous naked short sales. It could not only exceed the amount of available stock, it could potentially exceed the amount of outstanding stock.

Established trading practices have always viewed naked short selling as a violation of reasonable and prudent trading practices. Additionally, as noted above, naked short selling has the potential for seriously disrupting trading in a stock. To sharply limit this practice and its negative effects on the stock market, securities regulations require a broker to buy, at the naked short sellers' expense, the stock to cover the short position, on the 14^{th} trading day after the original closing date of the naked short sale, if the naked short seller has not already done so. Additionally, information on outstanding uncovered naked short sales must be provided to the public in the 13 days leading up to the date the broker has to buy the stock to cover the illegal naked short sale, along with every day thereafter that the stock remains on the Regulation SHO Threshold Security List.

The need to close out outstanding naked short sales within 13 days of the sale date can lead to significant spikes in the value of a stock with large outstanding naked short sales coming due at or near the same time. It can also lead to significant losses to the naked short seller.

In Jan. 3, 2005 Regulation SHO took effect and provides a new regulatory framework governing short selling of securities. It was designed with the objective of simplifying and modernizing short sale regulation and providing controls where they are most needed. At the conclusion of each settlement day, data is provided on securities in which: 1) there are at least 10,000 shares in aggregate failed deliveries for the security for five consecutive settlement days, and 2) these failures constitute at least 0.5% of the issuer's total shares outstanding. SEC Regulation SHO, under the Securities Exchange Act of 1934, mandates that, if a clearing agent has had a fail-to-deliver position for 13 consecutive settlement days, that clearing agent, and the broker/dealer it clears for, must purchase securities to close out its fail to deliver position.

The information on outstanding uncovered naked short sales now required to be provided by each of the securities exchanges can be very useful information to the investing public. However, this data, although available now to the general public, is not in a usable and practical format for the investor. Whether the investor is an institution or individual they have to spend hours reviewing the data and then update this information on a daily basis. Additionally, without readily accessible and easily analyzable information rumors can easily start regarding stocks subject to naked short sales. Thus, what is needed is system and method for providing this information in a practical and user friendly format. Additionally, this system and method should be easily updated on a daily basis.

### SUMMARY

Thus, it is an objective of the present invention to provide in a relational database contemporaneous, readily accessesable and analyzable information on outstanding naked short sales from major stock exchanges on a daily basis.

The present invention achieves these and other objectives by providing: a method and system that at the end of each business trading day gathers the current information made available by each of the major securities exchanges on stocks subject to outstanding naked short sales. This information is integrated into a single relational database from which a wide variety of related information on each stock subject to a naked short sale can be ascertained and compared to other stocks on the list. The information on each stock currently subject to a naked short sale includes: a) stock symbol, b) days on the list, c) current consecutive days on the list, d) last trade, e) percent change form previous trade, f) dollar change from previous trade, g) trade volume, h) time of last trade, i) the exchange they are traded on, j) a link to a stock charts and k) a link to an analysis of technical and other data. The stocks in this database than can be compared and analyzed with each other as follows: 1) those new to the list, 2) those off the list, 3) those that have an imminent buy to cover the short sale, 4) a listing of those in the database that have gained in value, 5) a listing of those in the database that have lost value, 6) those with high volume and 7) a list of those stocks that have bullish technical signals.

### BRIEF DESCRIPTION OF THE DRAWINGS

The invention will be better understood by an examination of the following description, together with the accompanying drawings, in which:

FIG. 1 is a flow chart that provides a summary of the overall system and method of the present invention;

FIG. 2 is an example of a web page that would, according to a preferred embodiment of the present invention, present a lists of stocks which are new to the list of outstanding stocks that subject to naked short sales;

FIG. 3 is an example of a web page that would, according to a preferred embodiment of the present invention, present a lists of stocks which have been removed from the list of outstanding stocks that are subject to naked short sales;

FIG. 4 is an example of a web page that, according to a preferred embodiment of the present invention, presents a lists of stocks on the list of outstanding stocks subject to naked short sales which are subject to an imminent buy requirement;

FIG. 5 is an example of a web page that would, according to a preferred embodiment of the present invention, present an analysis of a stock listed on the naked short sales list;

FIG. 6 is an example of a web page that would, according to a preferred embodiment of the present invention, present a lists of stocks which are the top ten stocks on the list of outstanding stocks that subject to naked short sales that have had the highest increase in value;

FIG. 7 is an example of a web page that would, according to a preferred embodiment of the present invention, present a list of the top ten stocks on the list of outstanding stocks subject to naked short sales which have had the most significant loss in value; and

FIG. 8 is an example of a web page that would, according to a preferred embodiment of the present invention, present a list of the top 10 stocks on the list of outstanding stocks that subject to naked short sales which have had the highest sales volume.

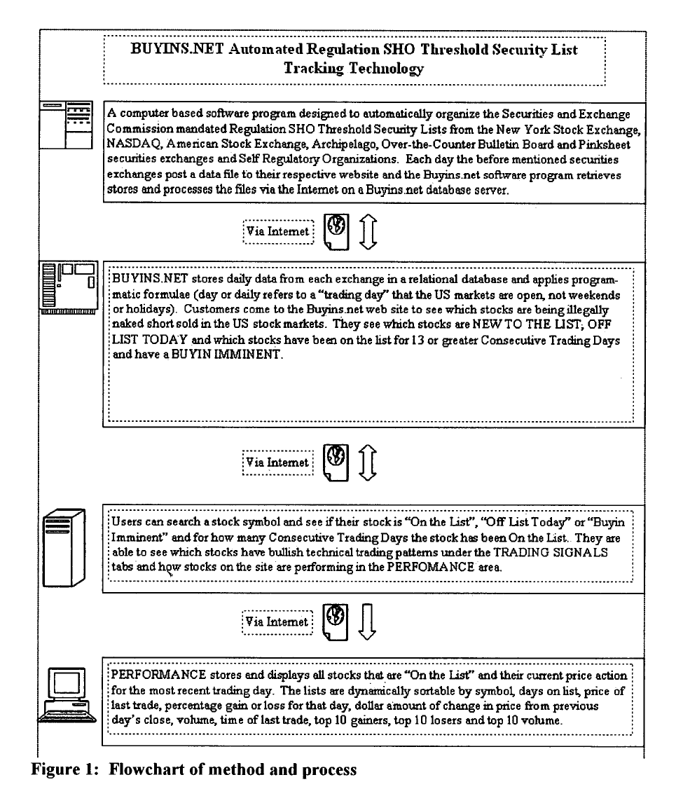

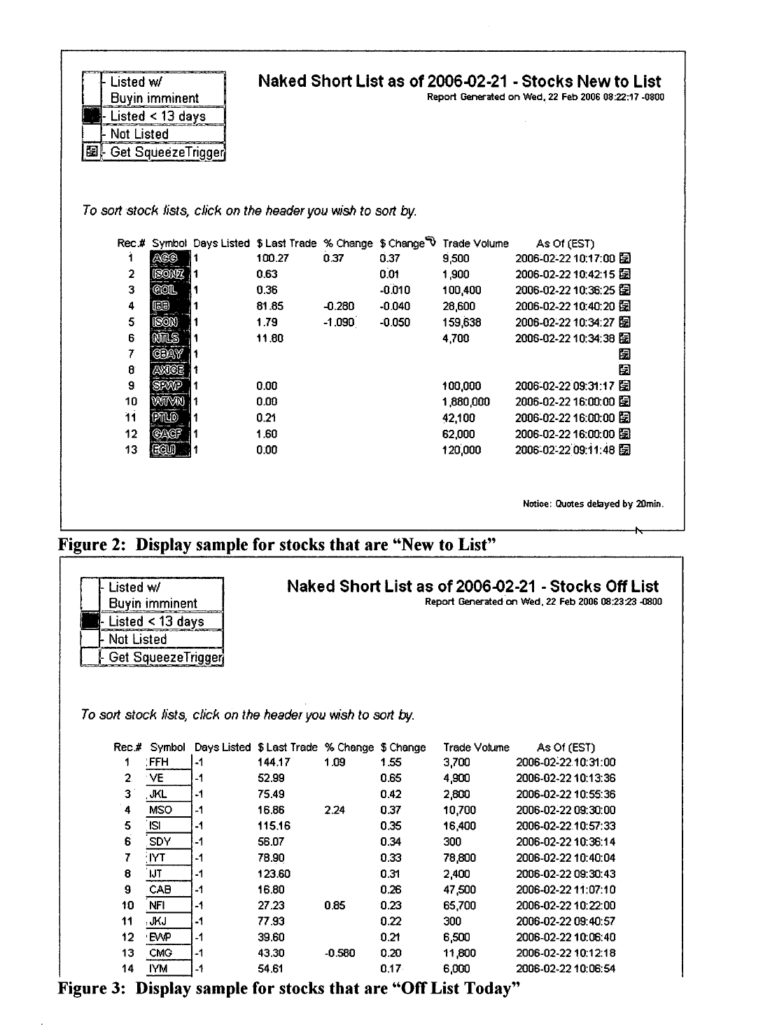

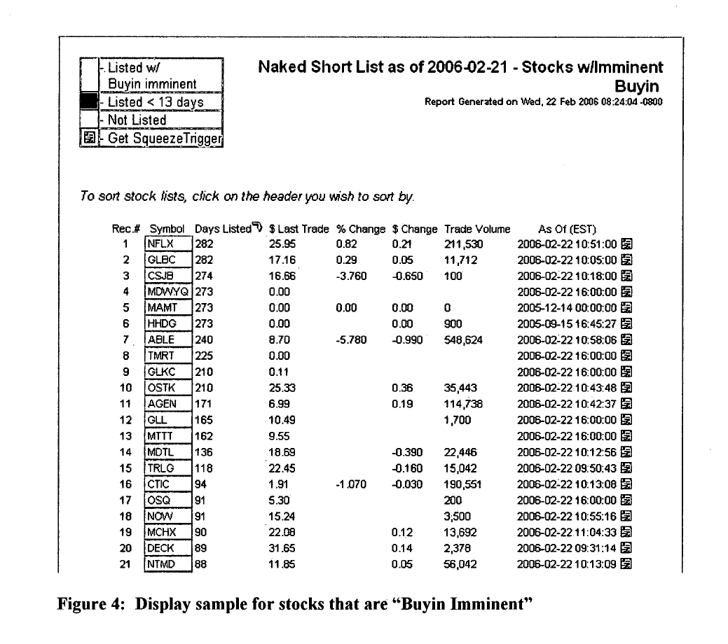

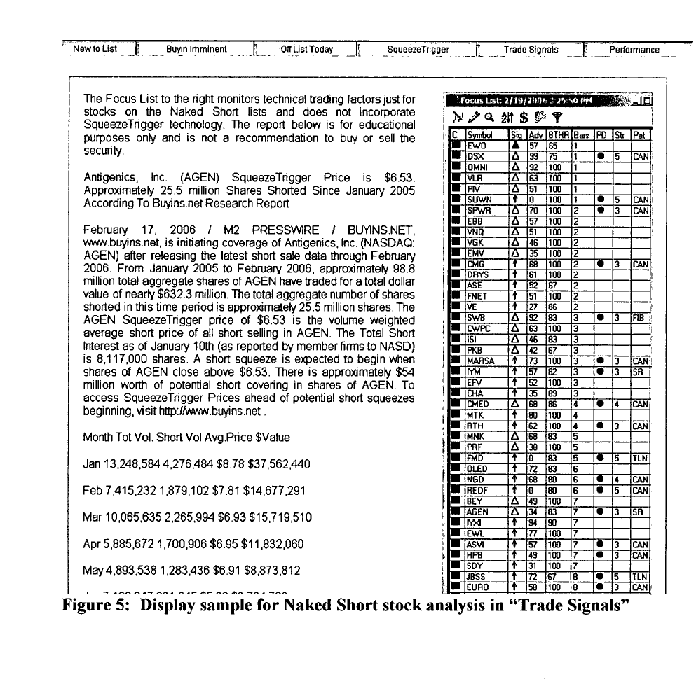

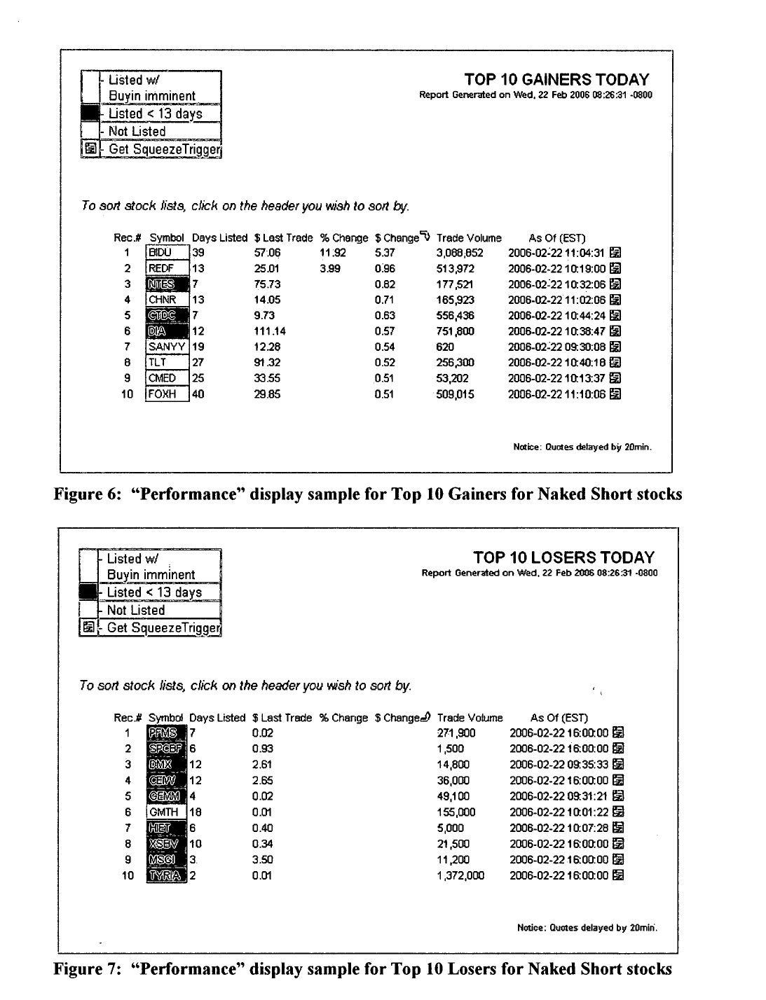

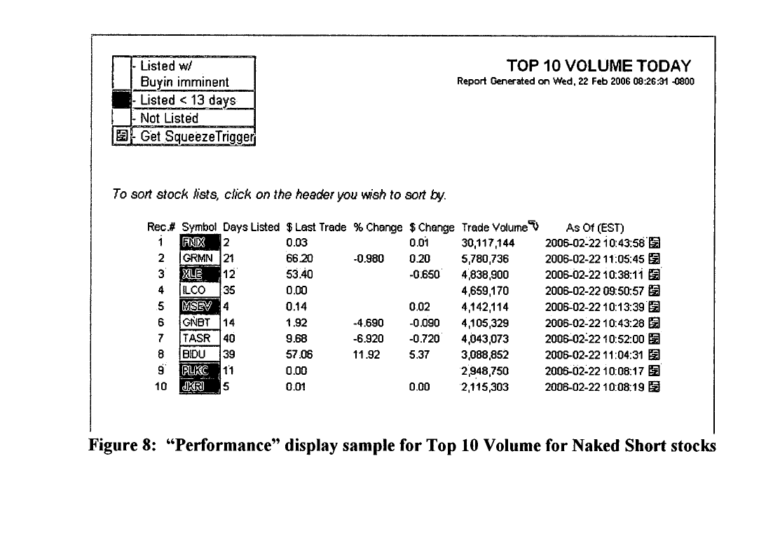

### DETAILED DESCRIPTION OF THE PREFERRED EMBODIMENT

The preferred embodiment of the present invention is a system and method embodied in a computer program that automatically organizes the Securities and Exchange Commission mandated Regulation SHO Threshold Security Lists from the New York Stock Exchange, NASDAQ, American Stock Exchange, Archipelago, Over-the-Counter Bulletin Board and Pinksheet securities exchanges and Self Regulatory Organizations. Each day the before mentioned securities exchanges post a file (from the source URL listed below):

ftp://ftp.nasdaqtrader.com/SymbolDirectory/regsho/nasdaqth(insert date here).txt
http://www.nasdaqtrader.com/trader/tradingdata/regsho/regshoad(insert date here).txt
http://www.amex.com/amextrader/tradingData/data/RegSHO/daily/AMEXth(insert date here).txt
http://www.nyse.com/threshold/NYSEth(insert date here).txt
http://www.tradearca.com/traders/SECreg/SHO/ARCAEXth(insert date here).txt

The method and system of the present invention downloads the data file (over the Internet) for each exchange which contains data in the format in Chart below:

Sample data file download (sample file has been truncated due to space constraints) in Chart 2 below:

The system and method of the present invention stores daily data from each exchange in a relational database and applies these programmatic formulae (day or daily refers to a “trading day” that the US markets are open, not weekends or holidays). In a preferred embodiment of the invention a Customers will come to web site that is using the system and method of the present invention to see which stocks are being illegally naked short sold in the US stock markets. They will see which stocks are NEW TO THE LIST, OFF LIST TODAY and which stocks have been on the list for 13 or greater Consecutive Trading Days and have a BUYIN IMMINENT. They will be able to search a stock symbol and see if their stock is on the list and for how many “most recent” Consecutive Days. They will be able to see which stocks have bullish technical trading patterns under the TRADING SIGNALS tabs and how stocks on the site are performing in the PERFORMANCE area.
1. Store and display stocks that are “New to List” by sorting the database for which stocks have been added to the Regulation SHO Threshold Security List for the first time or have been added back to the list after having been previously removed from the list.
2. Store and display how many “Consecutive Days” each stock has been on the list. If a stock is on the list for 5 days and then goes off for 2 days and then comes on for 4 days, the most recent number of “Consecutive Days” is 4. Post a list of all stocks that have a “Buyin Imminent” by sorting the database and displaying all stocks that have been “On the List” for 13 or greater consecutive trading days.
3. Store and display which stocks are “Off List Today” by querying the database for which stocks have been removed from the Regulation SHO Threshold Security List as of the most recent list downloaded from each exchange.
4. Store and display the exchange each stock trades on (NASDAQ, NYSE, AMEX, OTCBB, PINK or ARCAEX) and display the Regulation SHO Threshold Security List “By Exchange” on separate links using the “exchange titles”.
5. Store a query and display results for a web site visitor entering a stock symbol input via a search request that displays stocks are on the list for the 1 Consecutive Day (“On the List”); on the list for the 13^{th} Consecutive Day or more (“Buyin Imminent”), or request and receive “Number of Consecutive Trading Days on the List”. If a stock that is searched is not in the database, an error message that states “Stock you have selected is not currently on the Threshold List” is displayed.
6. Display a 3 month, 6 month and 1 year stock chart of the stock shown when someone searches the database. Here is a sample, Chart 3 below, of the 3 month stock chart for MSFT:
7. A list of dates on the left hand column when clicked will display the aggregated Regulation SHO Threshold Security List all of all exchanges for that given date.
8. Four buttons across the top of the website, read: STOCKS NEW TO LIST, BUYIN IMMINENT, TRADE SIGNALS, PERFORMANCE

STOCKS NEW TO LIST will display all stocks in database that are 1 Consecutive Day on list.

BUYIN IMMINENT will display all stocks in database that are on list for 13 or greater Consecutive Days on list.

TRADING SIGNALS displays a list of stocks that are “On the List” that have bullish technical trading signals.

PERFORMANCE stores and displays all stocks that are “On the List” and their current price action for the most recent trading day. The lists are dynamically sortable by symbol, days on list, price of last trade, percentage gain or loss for that day, dollar amount of change in price from previous day's close, volume, time of last trade, top 10 gainers, top 10 losers and top 10 volume.

What is claimed is:

1. A method for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide stock symbols for stocks that are currently included in the Securities and Exchange Commission mandated Regulation SHO Threshold Security Lists, real time stock price data sources provide stock price quote related information for stocks that are included, have been added to or removed from said Regulation SHO Threshold Security Lists, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating Threshold Security List conditions based on data collection; evaluating web site display conditions at time of data collection, wherein display and threshold conditions are set up to evaluate pre-defined conditions of incoming data and data that is displayed to a user.

2. A system for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide stock symbols for stocks that are currently included in the Securities and Exchange Commission mandated Regulation SHO Threshold Security Lists, real time stock price data sources provide stock price quote related information for stocks that are included, have been added to or removed from said Regulation SHO Threshold Security Lists, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating Threshold Security List conditions based on data collection; evaluating web site display conditions at time of data collection, wherein display and threshold conditions are set up to evaluate pre-defined conditions of incoming data and data that is displayed to a user.

3. Computer-executable process steps in computer readable memory, for collecting data for analysis from multiple data sources, comprising: receiving data from the multiple data sources in accordance with an automated data retrieval schedule; wherein multiple data collectors retrieve data from multiple stock exchange data sources, multiple real time stock price data sources and multiple legacy system data sources; wherein the stock exchange data sources provide stock symbols for stocks that are currently included in the Securities and Exchange Commission mandated Regulation SHO Threshold Security Lists, real time stock price data sources provide stock price quote related information for stocks that are included, have been added to or removed from said Regulation SHO Threshold Security Lists, and legacy data sources provide results of mathematical calculations performed on multiple data sources in a proprietary format; and the data retrieval schedule is set up by an automated time-based scheduler; parsing the data collected from the multiple data sources, wherein a parsing module parses the collected data; wherein a processor parses the data; evaluating threshold conditions based on data collection; evaluating web site display conditions at time of data collection, wherein display and Threshold Security List conditions are set up to evaluate pre-defined conditions of incoming data and data that is displayed to a user.
